(19) United States
(12) Patent Application Publication
(10) Pub. No.: US 2025/0322255 A1
(43) Pub. Date: Oct. 16, 2025

(54) Training a Student Model based on Agent-Generated Examples and Direct Application of Preferences

(71) Applicant: Microsoft Technology Licensing, LLC, Redmond, WA (US)

(72) Inventors: Arindam MITRA, Redmond, WA (US); Ahmed AWADALLAH, Redmond, WA (US); Corbin Louis ROSSET, Seattle, WA (US); Tengyang XIE, Cambridge, MA (US)

(73) Assignee: Microsoft Technology Licensing, LLC, Redmond, WA (US)

(21) Appl. No.: 18/636,212

(22) Filed: Apr. 15, 2024

(51) Int. Cl. G06N 3/096; G06N 3/042

(52) U.S. Cl. CPC G06N 3/096; G06N 3/042

(57) ABSTRACT

A technique trains a student language model by: obtaining a source item that contains content; generating plural tasks based on the content using a group of example-generating agents; transforming the plural tasks into plural teacher-generated responses using a teacher language model; transforming the plural tasks into student-generated responses using the student language model; and updating parameters of the student language model based on the student-generated responses and corresponding teacher-generated responses. The teacher language model performs operations to enhance the accuracy of the teacher-generated responses, but the student language model is only exposed to the teacher-generated responses themselves. The updating of the student language model's parameters involves consulting the teacher model to verify the suitability of one or more candidate student-generated responses. In some implementations, the technique performs optimization to find a Nash equilibrium given preference information, without implicit or explicit reward maximization.

### BACKGROUND

Some language models have a relatively large number of parameters, e.g., several hundred billion parameters in the case of some large language models. Many computing platforms are not capable of storing and implementing such a large language model. For example, a user computing device that has limited memory and processing resources may not be able to feasibly implement a large language model. It is also impractical to download a large language model from a source system.

The technical literature has proposed numerous techniques for training smaller language models that are more memory efficient and processor efficient compared to larger language models. One such technique is knowledge distillation, in which a relatively small language model learns from ground-truth labels provided by a larger language model. Smaller models trained in this way, however, generally have lower accuracy and generalizability compared to their larger language model counterparts.

### SUMMARY

A technique is described herein for training a student model that includes: obtaining a source item that contains content; generating plural tasks based on the content using a group of example-generating agents; transforming the plural tasks into plural teacher-generated responses using a teacher model; transforming the plural tasks into student-generated responses using the student model; and updating parameters of the student model based on the student-generated responses and corresponding teacher-generated responses.

According to some implementations, the teacher model performs accuracy-boosting operations to enhance the accuracy of the plural teacher-generated responses. During training of the student model, however, the technique does not inform the student model of at least some of the processes by which the teacher model produced the teacher-generated responses.

According to some implementations, the example-generating agents in the group are organized in a graph. The graph specifies input-output connections among the group of example-generating agents. At least some of the example-generating agents produce questions based on the source item.

According to some implementations, at least one task is produced using a first example-generating agent that produces an intermediate result, and a second example-generating agent that performs further processing on the intermediate result.

According to some implementations, the transforming of the tasks by the student model includes, for a particular task: producing one or more candidate student-generated responses to the task; assessing the suitability of each of the one or more candidate student-generated responses using a judgment agent (such as the teacher model itself), to provide preference information; and updating parameters of the student model based on the one or more student-generated responses, the preference information, and any ground-truth responses provided by the teacher model. In some implementations, the technique repeats the producing, assessing, and updating one or more times on a batched basis to successively improve performance of the student model. In each repetition of the updating, the parameters of a next version of the student model are based, in part, on parameters of a current version of the student model. This manner of operation can be referred to as self-improving insofar as the student model effectively learns from an earlier version of itself. Overall, the iterative batched-based technique is proven to monotonically improve quality and performance of the student model across iterations.

According to some implementations, the technique performs optimization to find a Nash equilibrium with respect to preference information provided by some oracle. Generally, the Nash equilibrium is a state in which each player in a non-cooperative environment makes a decision that the player believes to confer the optimal rewards to itself, given the player's knowledge of decisions and associated rewards taken by other players with which the player interacts. In other words, the Nash Equilibrium is a state in which neither player is incentivized to deviate from its current decisions, which are optimal against any other playing strategy. In some implementations, technique applies a loss function that uses contrastive updating and directly applies preferences established by the preference information without the explicit calculation of a reward function, and without performing explicit or implicit reward maximization.

According to one technical benefit, the technique provides a time-efficient, resource-efficient, and scalable way of generating a large number of useful training examples. According to another technical benefit, the technique produces a trained student model that offers superior performance to other models of a similar size that have been created using other training techniques. According to another technical benefit, the process of updating the parameters of the student model is resource efficient and scalable, and also effectively addresses general expressions of preferences, which other reward-based techniques (e.g., that use reward maximization) cannot express. These and other technical benefits will be explained herein in detail.

Examples are presented herein in which the above-summarized features are integrated in a single system. Note, however, that the functionality for producing training examples using example-generating agents can be gainfully applied to other systems that do not incorporate the specific approach to training the student model described herein, and vice versa.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an example-generating system for producing training examples using a task-generating system and a teacher model.

FIG. 2 shows a training system for training a student model based on the training examples produced by the example-generating system of FIG. 1.

FIG. 3 shows a client device for implementing a trained student model produced by the training system of FIG. 2.

FIG. 4 shows a network-based implementation of the trained student model produced by the training system of FIG. 2.

FIG. 5 shows different example-generating agents provided by the task-generating system of FIG. 1.

FIG. 6 shows a graph for establishing input-output relationships among the example-generating agents of FIG. 5.

FIGS. 7 and 8 show examples of the operation of different example-generating agents summarized in FIG. 5.

FIG. 9 shows an accuracy-boosting approach used by the teacher model to produce teacher-generated responses in the example-generating system of FIG. 1.

FIG. 10 shows an example of the approach of FIG. 9.

FIG. 11 shows one implementation of the training system of FIG. 2.

FIG. 12 shows an illustrative prompt that the training system of FIG. 11 provides to the teacher model, which explains how the teacher model is expected to generate preference information for candidate responses.

FIG. 13 shows the performance of the training system of FIG. 2 against other models.

FIG. 14 shows an illustrative language model for implementing the teacher language model and/or the student model shown in the above figures.

FIG. 15 is a flowchart that provides an overview of one manner of operation of the example-generating system and the training system of FIGS. 1 and 2, emphasizing the functionality shown in FIG. 1.

FIG. 16 is a flowchart that provides an overview of one manner of operation of the example-generating system and the training system of FIGS. 1 and 2, emphasizing the functionality shown in FIG. 2.

FIG. 17 is a flowchart that provides an overview of one manner of operation of a task-generating system, which is part of the example-generating system of FIG. 1.

FIG. 18 shows an illustrative type of computing system that, in some implementations, is used to implement any aspect of the features shown in the foregoing drawings.

The same numbers are used throughout the disclosure and figures refer to like components and features.

### DETAILED DESCRIPTION

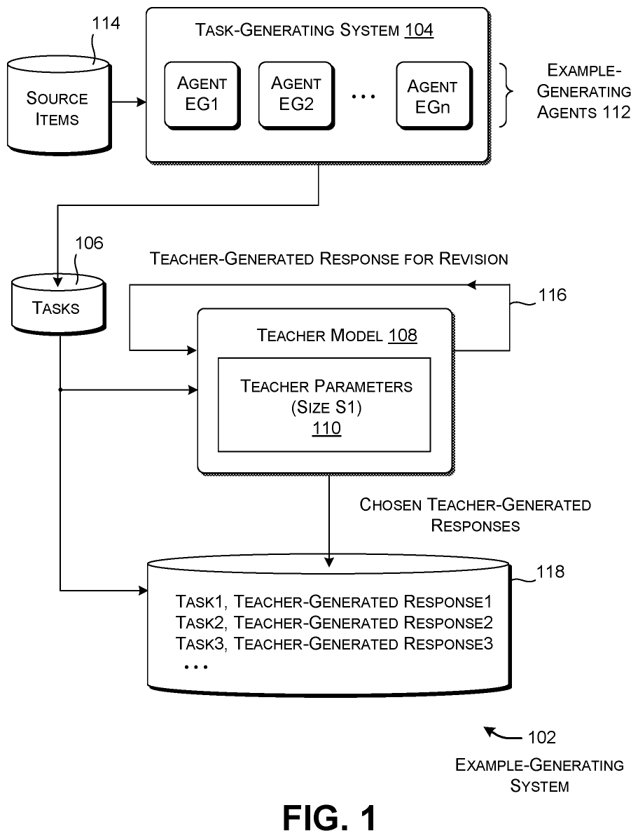

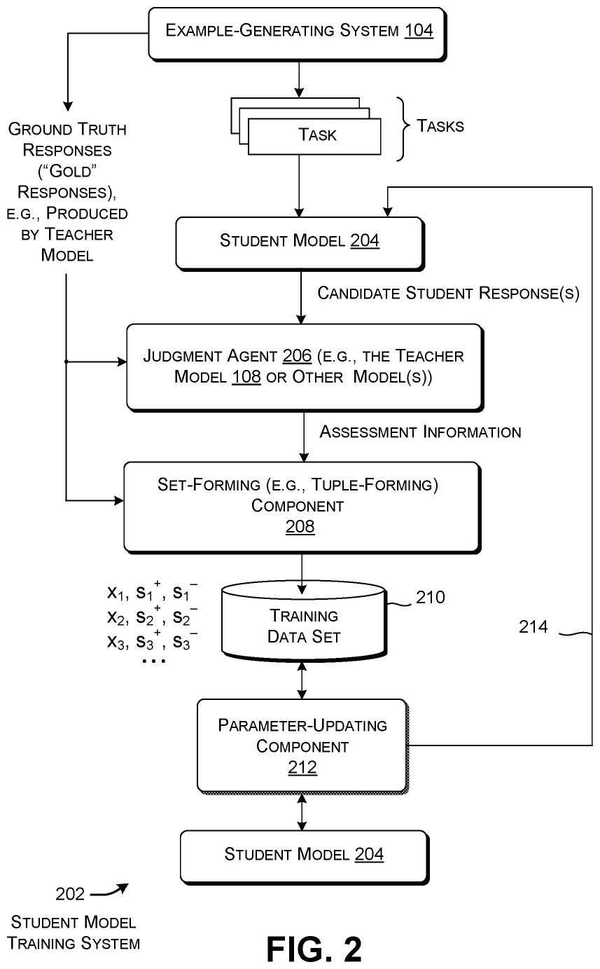

FIG. 1 shows an example-generating system 102 for producing training examples. The example-generating system 102 includes a task-generating system 104 for generating plural tasks and storing the tasks in a data store 106, and a teacher language model 108 (“teacher model” for brevity) for processing the tasks to produce teacher-generated responses. FIG. 2 shows a training system 202 for training a student language model 204 (“student model” for brevity). The training system 202 relies on an iterative learning process that involves interaction with the teacher model 108 to verify the suitability of student-generated responses. In some implementations described herein, the training system 202 performs optimization to find a Nash equilibrium, given preference information provided by some oracle (e.g., the teacher model 108).

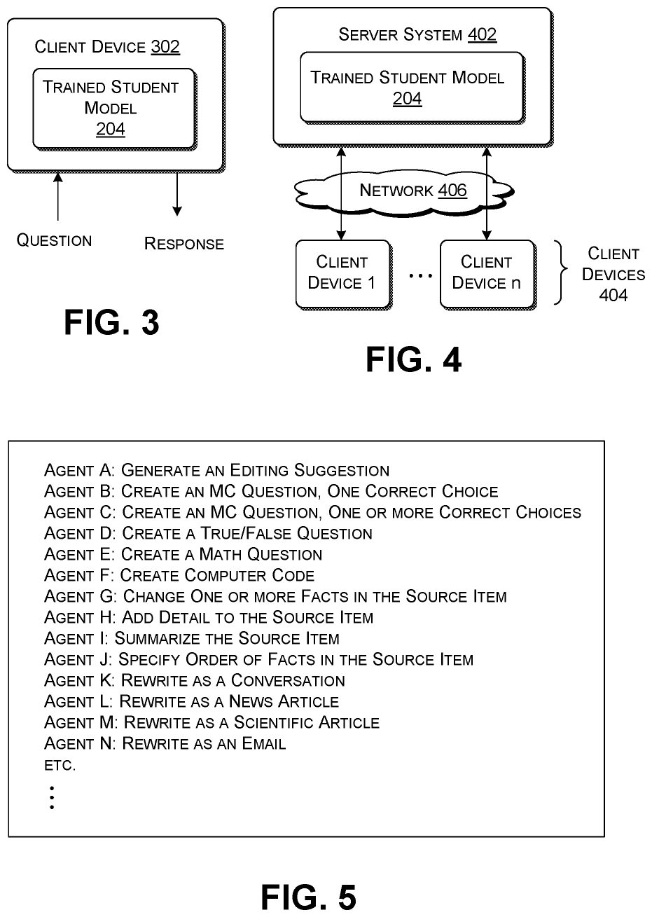

The following terminology is relevant to some examples presented below. A “machine-trained model” or “model” refers to computer-implemented logic for executing a task using machine-trained parameters that are produced in a training operation. A “parameter” refers to any type of value (e.g., a weight or bias value) that is iteratively produced by the training operation. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “prompt” refers to a sequence of tokens submitted to a machine-trained model. A “distributed vector” expresses the semantic content of an information item by distributing information over its k dimensions. A distributed vector is in contrast to a sparse one-hot vector that allocates particular dimensions of the vector to particular concepts. A “language model” refers to a model that, in the present context, generatively produces output information based on an input prompt. In some contexts, terms such as “component,” “module,” “engine,” and “tool” refer to parts of computer-based technology that perform respective functions. FIGS. 3, 4, and 18, described below, provide examples of illustrative computing equipment for performing these functions.

The teacher model 108 includes a first set of parameters 110 that is larger than a second set of parameters (not shown) used by the student model 204. For this reason, the teacher model 108 is said to have a larger size than the student model 204. For instance, in some implementations, the teacher model 108 includes several hundred billion parameters or more, while the student model 204 includes less than 30 billion parameters (such as 7 billion parameters in one example). The principles described herein, however, apply to combinations of teacher models and student models of any respective sizes such that, for each such combination, the teacher model is larger than the student model.

In some implementations, the teacher model 108 is any commercially available large language model, such as the GPT4 language model available from OpenAI of San Francisco, California. Another example of a large pre-trained language model is the BLOOM model described in Scao, et al., “BLOOM: A 176B-Parameter Open-Access Multilingual Language Model,” arXiv, arXiv:2211.05100v2 [cs.CL], Dec. 11, 2022, 62 pages. In some implementations, the student model 204 is a fine-tuned version of an LLaMA model. Background information on the general topic of the LLaMA model is provided in Touvron, et al., “LLaMA: Open and Efficient Foundation Language Models,” arXiv, arXiv:2302.131271v1 [cs.CL], Feb. 27, 2023, 27 pages.

Starting with FIG. 1, the task-generating system 104 includes a group of example-generating agents (EG1, EG2, . . . EG3) 112 for generating the tasks based on source items in a data store 114. A source item is any type of item that includes any type(s) of content, including text content, image content, video content, audio content, etc., or any combination thereof. A task is a request for a language model to perform specified operations. A data store 106 stores the tasks.

More specifically, the example-generating agents in a first subgroup produce tasks that depend on content provided by a particular source item. One example of this type of example-generating agent is an agent that produces a question based on information provided by a source item. Example-generating agents of a second subgroup produce intermediate results based on the content provided by the particular source item. A downstream example-generating agent generates a task on the basis of an intermediate result provided by an example-generating agent of the second subgroup. Alternatively, the downstream example-generating agent produces another intermediate result. More generally, the task-generating system 104 can use any number of example-generating agents to produce a task, connected in any manner.

The teacher model 108 generates a teacher-generated response for each task produced by the task-generating system 104. For example, for the case in which the task is a question, the teacher model 108 generates a response to the question. In some implementations, the teacher model 108 also performs accuracy-boosting operations for the purpose of enhancing the accuracy—or more generally, the appropriateness—of its response. In some examples, for instance, the accuracy-boosting operations include checking the accuracy of a first teacher-generated response, and, based thereon, revising the first teacher-generated response to produce a second teacher-generated response. The second teacher-generated response has enhanced accuracy compared to the first teacher-generated response. Alternatively, or in addition, the accuracy-boosting operations include guiding the target model 108 to produce another teacher-generated response, e.g., based on a new system instruction that is supplied to the teacher model 108. A path 116 generally represents the possible enhancement of a teacher-generated response, in one or more iterations.

A data store 118 stores training examples, each of which includes a task x produced by the task-generating system 104 and a teacher-generated response yₜ produced by the teacher model 108. The subscript t represents “teacher.”

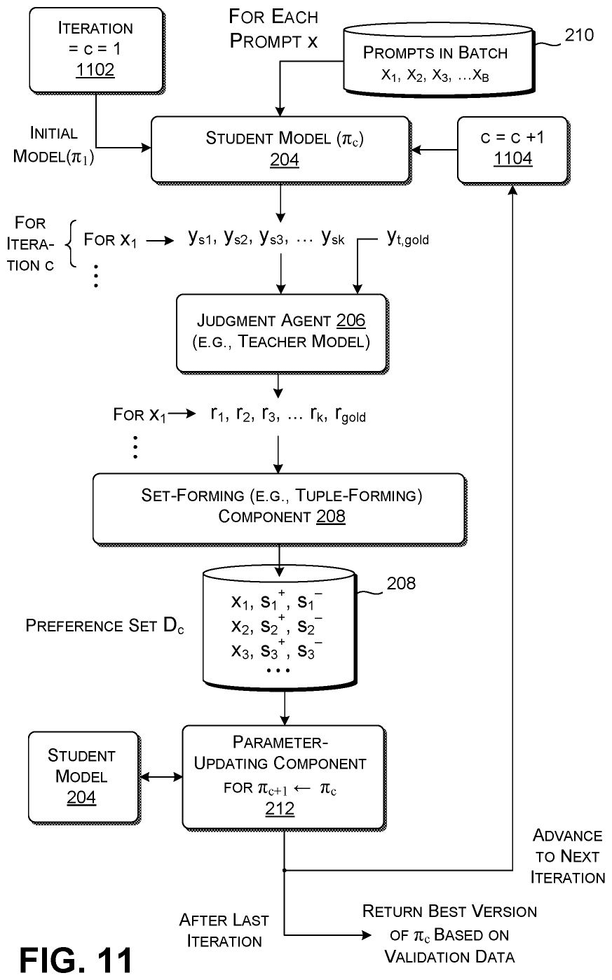

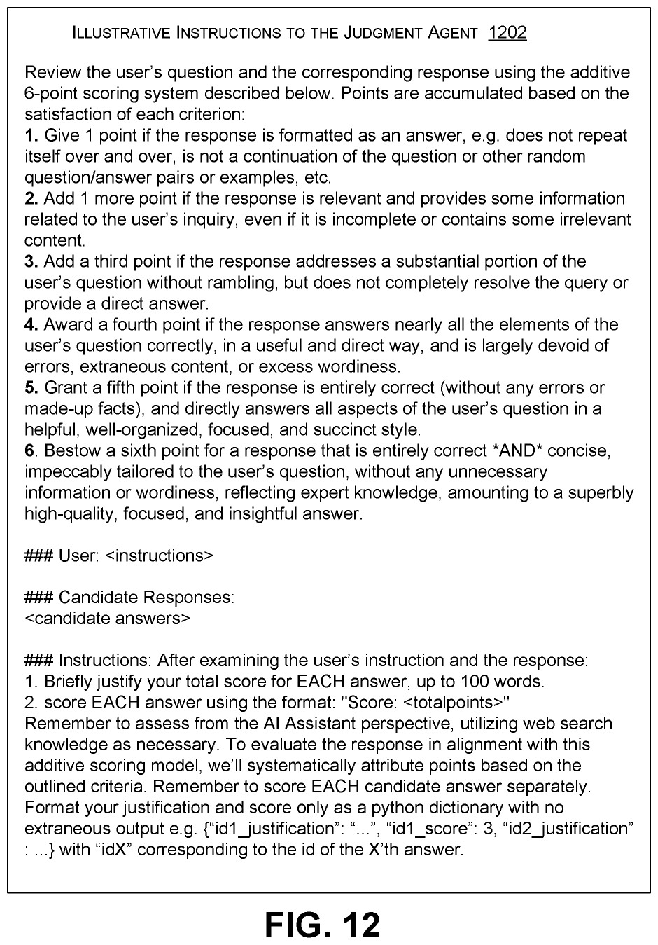

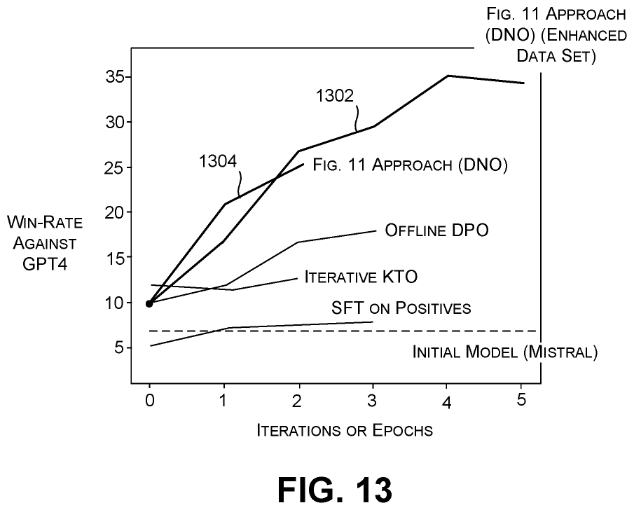

Advancing to FIG. 2, a task x in a batch of tasks is sampled from a distribution p of tasks produced by the example-generating system 102 and/or any other source(s). The training system 202 uses the student model 204 to transform the task x into one or more candidate student-generated responses (yₛ₁, yₛ₂, . . . , y_{sK}). The subscript s represents “student.” The training system 202 then relies on a judgment agent 206 to determine whether each candidate student-generated response produced for each x is accurate and/or otherwise suitable based on some environment-specific standard of appropriateness. In some implementations, the judgment agent 206 identifies each candidate student-generated response as accurate, in part, if it matches the teacher-generated response yₜ associated with the task x, as previously determined by the example-generating system 102. In this sense, the teacher-generated response serves as a ground-truth response. In other implementations, the training system 202 treats the teacher-generated response yₜ as another candidate response to be evaluated by the judgment agent 206, along with the candidate student-generated responses. The explanation of FIG. 11 below will provide further details regarding the latter implementation.

In some implementations, the judgment agent 206 is implemented by the teacher model 108 itself. Alternatively, or in addition, the judgment agent 206 is implemented by another type of machine-trained model besides the teacher model 108, and/or an ensemble of plural machine-trained models and/or tools. In any case, the judgement agent 206 produces preference information based on its operation. In some examples, the preference information collectively represents the scores r₁, r₂, r₃ assigned by the judgment agent 206 to the respective candidate student-generated responses.

For each task under consideration x, a set-forming component 208 produces at least one subset (e.g., at least one tuple) that includes the task x, at least one positive response y⁺ and at least one negative response y⁻. Illustrative criteria for selecting this subset will be set forth below in connection with the explanation of FIG. 11. Generally, a positive response is an response that is assessed as a satisfactory response to the task x based on any standard of appropriateness, and a negative response is an response that is assessed as an unsatisfactory response to the task x based on the standard of appropriateness. In some implementations, for instance, the set-forming component 208 chooses the subset such that: (a) the positive candidate response has a score above a prescribed threshold value; and (b) the negative candidate response has a score that is lower than the positive candidate response's score by at least a prescribed amount. If there are no negative candidate responses that meet this test, then the set-forming component 208 can randomly select an response associated with another task, the presumption being that these responses will have a sufficiently low relevance to the current task, and therefore differ from the positive candidate response by more than the required amount. A data store 210 stores the subsets, e.g., by storing subsets for all of the tasks in a batch being processed.

A parameter-updating component 212 iteratively trains the student model 204 based on the training examples in the data store 210. Generally, the parameter-updating component 212 performs this task by iteratively adjusting the parameters of the student model 204 to increase the likelihood that the student model 204 will produce an accurate response, given a particular task, and decrease the likelihood that the student model 204 will produce an inaccurate response for the particular task.

The parameter-updating component 212 can use any loss function to perform this task, such as any Human-Aware Loss function (HALO). One such HALO is the Kahneman-Tversky Optimization (KTO) loss function described in Ethayarajh, et al., “KTO: Model Alignment as Prospect Theoretic Optimization,” arXiv, arXiv:2402.01306v1 [cs.LG], Feb. 2, 2024, 18 pages. Another loss function is the Direct Preference Optimization (DPO) approach described in Rafailov, et al., “Direct Preference Optimization: Your Language Model is Secretly a Reward Model,” arXiv, arXiv:2305.18290v2 [cs.LG], Dec. 13, 2023, 27 pages. Code that implements various HALOs, including the KTO approach and the DPO approach, is publicly available at the Github website provided by Microsoft Corporation of Redmond, Washington. Other implementations use supervised fine-tuning (which uses cross-entropy) to update the parameters of the student model 204.

Alternatively, or in addition, the parameter-updating component 212 applies a custom loss function developed by the present inventors to compute loss. FIG. 11, for instance, will present an example in which the parameter-updating component 212 performs optimization using a custom loss function to find a Nash equilibrium, given the preferences set forth by some oracle. Further, in some implementations, the loss function uses contrastive updating of parameters, and eliminates the need for explicitly modeling a reward function. It also eliminates the need for explicit or implicit reward maximization. Contrastive updating attends to specified relations among matching and non-matching model responses.

The Nash equilibrium is a state in which each player in a non-cooperative environment makes a decision that the player believes to confer the optimal rewards to itself, given the player's knowledge of decisions and associated rewards taken by other players with which the player interacts. In other words, the Nash Equilibrium is a state in which neither player is incentivized to deviate from its current decisions, meaning that a player's decisions are considered better than other alternatives.

For instance, consider a two-player zero-sum game between a first player who pursues a policy π and a second player who pursues a policy π′. Zero-sum means that the first player is given a payoff [symbol] (π [symbol] π′) and the second player is given a complementary payoff [symbol] (π′ [symbol] π)=1− [symbol] (π [symbol] π′). Mathematically expressed, both players will converge on a mutually agreeable policy π* that is given by the minimax theorem:

$${π}^{*} {=}^{def} {arg max}_{π} {min}_{{π}^{′}} 𝒫 ( π ≻ {π}^{′} ) . 𝒫 ( π ≻ {π}^{′} )$$

is the preference between the two policies given by [symbol] _{x˜ρ,y˜π(⋅|x),y′˜π′(⋅|x)}[ [symbol] (y [symbol] y′)|x)], where [symbol] is the expectation operator, and y and y′ are actions chosen under policies π and π′, given the tasks. In the present context, the actions represent responses to tasks. The argmax-min operation minimizes worst-case assessments of loss. A player is a hypothesized decision-maker, associated with a policy, that provides a set of responses to different tasks.

The use of the Nash equilibrium accommodates the possibility that some of the preferences among responses are non-transitive (meaning, for instance, that users may prefer response X over response Y, response Y over response Z, yet still prefer response Z over response X). Further, preferences are stochastic and non-Markovian. Eliminating the use of a reward function (and reward maximization) is advantageous because it is generally not possible to express the values of preferences consistently with “point-wise” rewards.

The loop 214 of FIG. 12 indicates that the training system 202 can repeat the above-described operations for another batch of tasks and associated ground-truth responses. As will be described more fully below with reference to FIG. 11 and Equations (1) and (2), the parameter-updating component 212 updates the parameters of the student model 204 for a next version of the student model 204 using contrastive loss based, in part, on student-generated responses generated by a current version of the student model 204. This manner of operation can be referred to as self-improving insofar as the student model 204 successively improves its performance for each new version of the student model 204 on the basis of a current version of the student model 204. Further, insofar as the iterative process samples student-generated responses from the most recent version of the student model 204, it may be referred to as “on policy.” Overall, the iterative batch-based technique described above is proven to monotonically improve quality and performance of the student model 204 across iterations.

Further note that the training system 202 optionally performs supervised fine-tuning (SFT) of the student model 204 prior to the above-described processing, e.g., by computing loss using the cross-entropy loss function based on ground-truth responses. In its initial form, prior to any of the above-described training, the student model 204 represents a pre-trained language model, such as an LLaMA pre-trained model.

In the above explanation, the example-generating system 102 and the training system 202 work as a single training framework to train the student model 204. In other implementations, a training framework uses the functionality of the example-generating system 102 without some aspects of the functionality of the training system 202. For example, in alternative implementations, the task-generating system 104 is applied in a system without use of optimization that finds a Nash equilibrium, and vice versa.

The example-generating system 102 is technically advantageous because it provides a way to quickly generate a large number of high-quality training examples with reduced interaction by human analysts. The example-generating system 102 is particularly useful when there is a scarcity of pre-existing examples from which to learn. The use of a robust training set, in turn, enables the training system 202 to produce an accurate student model 204. The accuracy-boosting provisions described above further enhance the quality of the training examples, which contributes to the production of an accurate student model.

Further, the example-generating system 102 is scalable and resource-efficient because it can quickly be adapted to new training environments with new training objectives. In particular, a developer can adapt the example-generating system 102 by defining one or more chains of example-generating agents and the functions and prompts associated therewith.

The training system 202 also has various technically useful features. For example, the teacher model 108 applies different strategies to produce high-quality responses for different classes of tasks. The training system 202 exposes the high-quality responses to the student model 204, but not the strategies by which these responses were produced. This forces the student model 204 to independently discover appropriate strategies to apply to different kinds of tasks (such as different classes of queries). This reduces the likelihood that the student model 204 will learn superficial patterns exhibited by the instructions specified in prompts. Note, however, that there is no expectation that the student model 204 will adopt the same strategies as the teacher model 108 for different classes of query. This is because the student model 204 has different capabilities than the teacher model 108, and, as such, the student model 204 may arrive at a different optimal policy for some query classes than the teacher model 108. This is another reason why it is useful for the teacher model 108 to refrain from sending some details regarding its derivations to the student model 204.

As will be explained below, the training system 202 also eliminates the need to explicitly calculate reward signals associated with the candidate responses generated by the student model 204. This is beneficial because precise reward information is generally not available, at least in direct form. Other efficiencies of the training approach will be set forth below in the context of the explanation of FIG. 11.

Further note that the training system 202 expresses preferences in a generalized pairwise manner, e.g., by specifying that a first candidate response y is better than a second candidate response y′ for a specified task x, based on guidance from the teacher model 108. Techniques that use explicit reward functions do not have this capacity, as they generate a single response y to the input x, which is a “pointwise” reward. Techniques that rely on the BT model are similarly restricted. General background information on the Bradely-Terry (BT) model is available at Bradley, et al., “RANK ANALYSIS OF INCOMPLETE BLOCK DESIGNS: THE METHOD OF PAIRED COMPARISONS,” Biometrika, Vol. 39, Issue 3-40, December 1952, pp. 324-345.

FIG. 3 shows a client device 302 for implementing a trained student model 204 produced by the training system 202 of FIG. 2. The client device 302 is any type of computing device, including any of a desktop computing device, a laptop computing device, a handheld computing device of any type (e.g., a smartphone or a tablet-type computing device), a mixed reality or virtual reality device, an intelligent appliance, a wearable computing device (e.g., a smart watch), an Internet-of-Things (IoT) device, a gaming system, a media device, a vehicle-borne computing system, any type of robot computing system, a computing system in a manufacturing system, etc. In other implementations, two or more local client devices cooperate with each other to implement the trained student model 204.

FIG. 4 shows a server system 402 that implements a trained student model 204 produced by the training system 202 of FIG. 2. One or more client devices 404 interact with the server system 402 via a computer network 406, e.g., via browser applications provided by the client devices 404. The server system 402 is implemented by one or more servers. Each client device represents any type of computing device described above. The computer network 406 is implemented as a local area network, a wide area network (e.g., the Internet), one or more point-to-point links, or any combination thereof. In other implementations, some functions of the trained student model 204 are implemented by the server system 402 and other functions of the trained student model 204 are implemented by one or more computing devices.

Although not shown, the example-generating system 102 and the training system 202 can be implemented by functionality distributed in any way between one or more client devices and the server system 402. For example, in some implementations, the server system 402 implements the teacher model 108; all other functions of the example-generating system 102 and the training system 202 are implemented by one or more client devices. In other implementations, all functions of the example-generating system 102 and the training system 202 are implemented by the server system 402.

FIG. 5-13 show illustrative details of the example-generating system 102 of FIG. 1 and the training system 202 of FIG. 2. Beginning with FIG. 5, this figure shows different kinds of example-generating agents provided by the task-generating system 104 of FIG. 1. As will be clarified in the examples to follow, example-generating agents of a first subgroup directly generate tasks. For example, the Agent B produces a multiple choice (MC) question having a single correct response based on a source item. Example-generating agents of a second subgroup generate intermediate results. A downstream example-generating agent then produces a task on the basis of the intermediate results. Alternatively, the downstream example-generating agent generates another instance of intermediate results. Agent H is an example of the second group; it adds detail to the source item that is not found in the source item in its original form. Another second-group agent is agent K, which rewrites the source item as a conversation, and so on. In yet other examples, an example-generating agent produces an intermediate result that constitutes a task in its own right; but another downstream example-generating agent also uses that same intermediate result to produce another task.

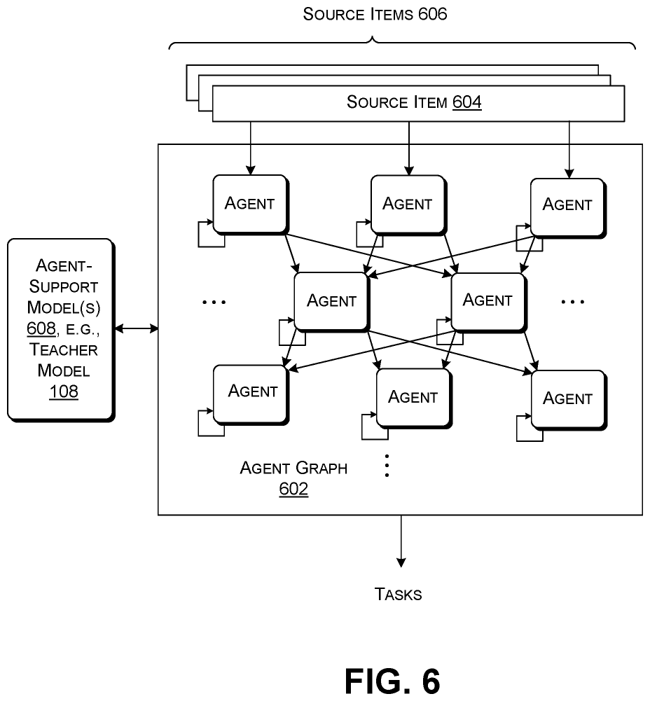

FIG. 6 shows a network of example-generating agents of different kinds organized by a directional graph 602. The graph 602 specifies some of the possible input-output relationships among different example-generating agents. That is, for any particular example-generating agent, the graph 602 specifies the source (or sources) of input information that is fed to the particular example-generating agent and the target destination (or target destinations) to which output information produced by the particular example-generating agent is sent. A looping arrow that points back to each example-generating agent indicates that any example-generating agent is capable of being called two or more times in succession, with output information generated by the example-generating agent being fed back to it as input information.

More specifically, in some cases, a particular example-generating agent receives input information directly from a particular source item 604 being considered. The source item 604 is one of a plurality of such source items 606. In other cases, the particular example-generating agent receives intermediate results produced by another upstream example-generating agent. In other cases, the particular example-generating agent receives input from two or more entities, e.g., including any sources and/or intermediate example-generating agents.

Similarly, in some cases, the output information produced by the particular example-generating agent constitutes one or more final tasks, on which no further processing is performed by the task-generating system 104. In other cases, the output information produced by the particular example-generating agent is intermediate results that is provided to one or more downstream example-generating agents. In general, developers in different environments will define different flows of example-generating agents. Each flow uses a specified subset of the example-generating agents and produces one or more tasks.

In some implementations, at least some of the examples-generating agents in the graph 602 rely on one or more agent-support models 608. For example, consider an example-generating agent that produces a summary of the source item 604. The example-generating agent performs this function by producing a prompt that provides the source item 604 and that describes the summarization operation that is to be performed on the source item 604. An agent-support model transforms the prompt into a response that provides a summary of the source item 604. In some implementations, an agent-support model is a large language model that autoregressively produces the response. In some implementations, for instance, the agent-support model is implemented by the teacher model 108 itself.

In some examples, a developer uses the AutoGen framework to create example-generating agents, to define their roles, and to define their manner of interaction. AutoGen is a publicly accessible service provided by Microsoft Corporation, of Redmond, Washington, and is described in Wu, et al., “AutoGen: Enabling Next-Gen LLM Applications via Multi-Agent Conversation,” arXiv:2308.08155v2 [cs.AI], Oct. 3, 2023, 43 pages.

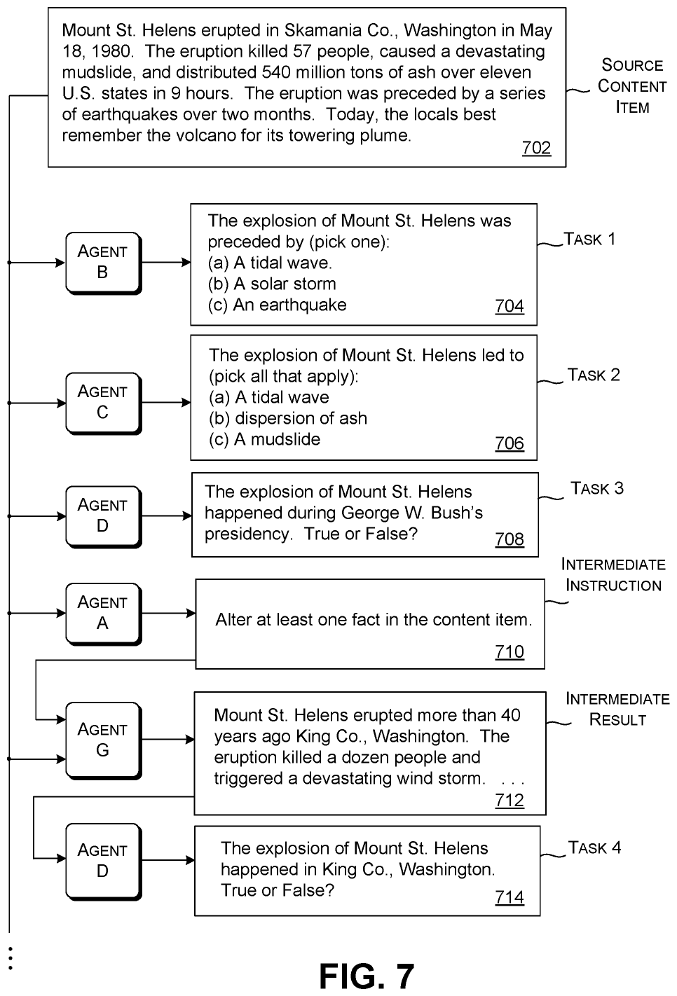

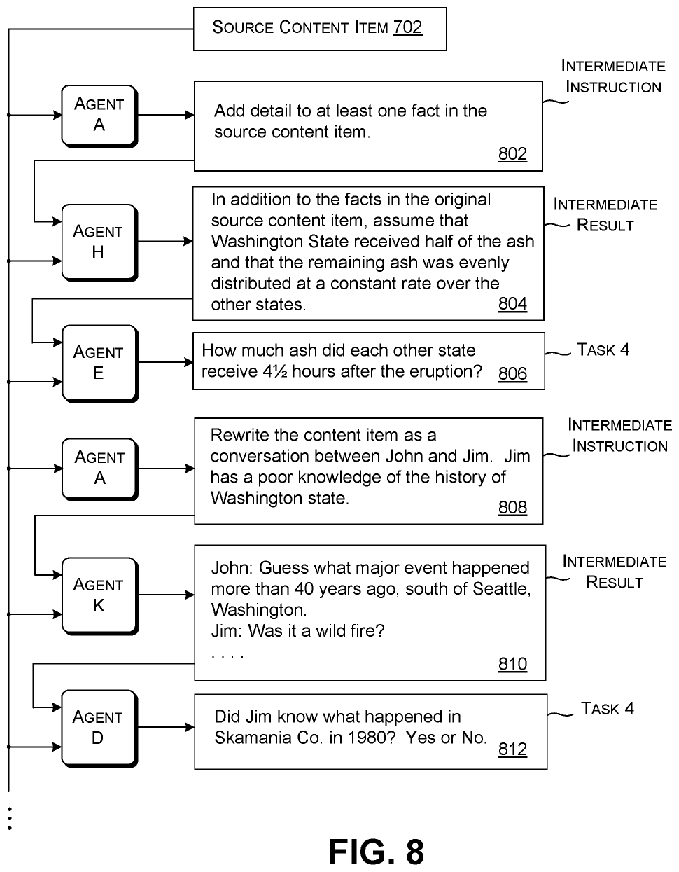

FIGS. 7 and 8 show examples of the operation of different example-generating agents summarized in FIG. 5. Starting with FIG. 7, assume that a source item 702 is an encyclopedia entry (e.g., a Wikipedia entry) describing the Mount St. Helens volcanic eruption of 1980 in Skamania Country, Washington. Agent B produces a multiple choice (MC) question 704 based on the source item 702, where only one choice is correct. Agent C produces a multiple choice question 706 based on the source item 702, with one or more choices being correct. Agent D produces a True-False question 708 based on the source item 702. Agent A produces one or more intermediate instructions based on the source item 702. Here, the intermediate instruction 710 that is produced specifies a request to alter one or more facts in the source item 702, to thereby render it counterfactual, at least in part. Agent G caries out the intermediate instruction 710, to produce a modified source item 712. Agent D produces a True-False question 714 based on the modified source item 712. The collective goal of Agents A, G, and D is to produce a task that will guide the student model 204 to learn how to adhere to the information that is actually imparted by a particular source item, and not to automatically apply any a priori knowledge it may possess about this historical incident.

Continuing with FIG. 8, Agent A produces an intermediate instruction 802 based on the source item 702, which requests that detail be added to the source item 702 that is not found in the source item 702 in its original form. Agent H carries out the intermediate instruction to produce the modified source item 804. Among other changes, the modified source item 804 adds detail about how the ash from the eruption was distributed, which is not imparted by the source item 702 in its original form. The added content need not conform to any historical record of the incident, and, in this sense, may be fictional. An example-generating Agent E asks a mathematical question 806 about the modified source item 804. The response to a mathematical question typically takes the form of numerical information. An agent solves a mathematical question by performing mathematical reasoning based on the input information specified in a source item and instructions about how to reason about a problem.

Agent A produces an intermediate instruction 808, which makes a request that the source item 702 be rewritten as a conversation between two individuals, John and Jim. Jim is stipulated to have a poor knowledge of the history of Washington state. Agent K carries out the intermediate instruction 808, to produce a conversation 810. Agent D produces a True-False question 812 based on the conversation 810.

The agent functions described above are to be understood as representative of many different ways that a source item can be transformed into a task or an intermediate result. Other implementations rely on other types of example-generating agents that perform other functions not specifically mentioned above. Alternatively, or in addition, other implementations omit one or more of the example-generating agents described above.

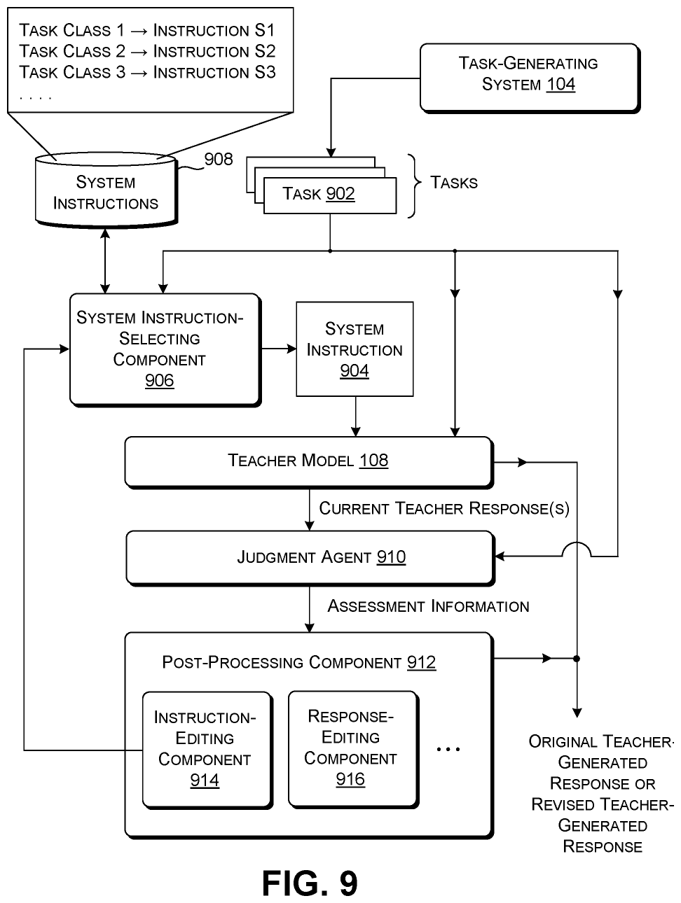

FIG. 9 shows further illustrative details regarding the operation of the teacher model 108 in the example-generating system 102 of FIG. 1. The operation of the functionality of FIG. 9 will be explained with respect to a particular task 902 produced by the task-generating system 104, which is one of the plurality of tasks 106. The objective of the functionality of FIG. 9 is to use the teacher model 108 to produce a high-quality teacher-generated response. One training example includes the task 902 and the teacher-generated response.

In some implementations, the teacher model 108 operates on a prompt that describes the task 902 and a system instruction 904. The system instruction 904 provides an explanation of how the teacher model 108 is to perform the task 902. In some implementations, a system instruction-selecting component 906 selects the system instruction 904 by first determining a class associated with the task 902. Each class is associated with a particular system instruction. Hence, by selecting a class, the system instruction-selecting component 906 also chooses a particular system instruction.

A data store 908 stores a lookup table or other data structure that associates different classes with respective system instructions. In some examples, as a preliminary offline operation, a class analysls system (not shown) empirically determines the relationships expressed in the lookup table or other data structure provided by the data store 908. For instance, the class analysls system uses cluster analysls to organize the tasks into strategy groups based on the strategies that have been determined to be most effective for these tasks. The class analysls system can perform a second level of analysls to discover the distribution of semantic content associated with any strategy group, e.g. using vector-based clustering.

The system instructing-selecting component 906 matches a task with a class using any technique, including keyword-matching operation, a lexical pattern-matching operation, a vector search operation, etc. For example, the keyword-matching operation matches keywords in the task 902 with keywords that are associated with each class. The vector-matching operation determines a first and second distributed vectors associated with the task 902 and each class (e.g., each strategy group that represents each class), respectively, and then determines a distance between the two distributed vectors. The vector-matching operation chooses the class that is closest in vector space to the task 902.

Any given system instruction can formulate its instruction by drawing on different available techniques. These techniques include: a) zero-shot prompting that does not use any illustrative examples of how to perform a task; b) few-shot prompting that provides a small number of examples of how to perform the task; c) chain-of-thought prompting that asks a language model to solve a problem using a specified sequence of steps; d) explanation-requesting prompting that asks the language model to explicitly articulate the steps associated with is derivation; e) recall-specific prompting that instructs the language model to consult a context memory (not shown) at one or more stages of its derivations, and so on, and any combinations thereof.

Next, the teacher model 108 transforms a prompt that includes a description of the task 902 and the system instruction 904 to at least one teacher-generated response. A judgment agent 910 performs analysls on the teacher-generated response to determine whether it is appropriate. In some examples, the judgment agent 910 is implemented by a large language model, such as the teacher model 108 itself. As a result of its analysls, the judgment agent 910 produces assessment information that expresses its conclusions. In other words, the teacher model 108 is capable of operating both as an response-generating engine and a critic, depending on the manner in which it is prompted.

The judgment agent 910 performs its function in different ways, depending on the particular kind of verification it is asked to perform and the particular instructions set forth in a prompt. In one implementation, the judgment agent 910 compares each statement of the teacher-generated response to determine whether it is empirically supported by the original source item 902. Alternatively, or in addition, the judgment agent 910 analyzes the teacher-generated response to determine whether it contains socially inappropriate content, such as sexist or racist content. Alternatively, or in addition, the judgment agent 910 analyzes the teacher-generated response to determine whether its conclusions are internally consistent. Alternatively, or in addition, the judgement agent 910 compares the teacher-generated response with an external ground-truth oracle, such as a knowledge base that specifies facts about a particular subject. Alternatively, or in addition, the teacher-generated response is code, and the judgement agent 910 is an execution engine (e.g., a compiler) that runs the code to determine whether it successfully runs and produces a desired result, and so on.

A post-processing component 912 performs any type(s) of post-processing actions on the basis of the task 902 and the preference information produced by the judgement agent 910. For example, an instruction-editing component 914 works in cooperation with the system instruction-selecting component 906 to select another system instruction that may be more successful in producing a good-quality teacher-generated response. Alternatively, or in addition, an response-editing component 916 edits the original teacher-generated response to remove any content that is determined to be incorrect or otherwise objectionable, and/or to add new content, and/or to perform any other type of modification of the response. In some implementations, the post-processing component 912 performs at least some of its functions by interacting with the teacher model 108.

The example-generating system 102 can repeat the above-described series of actions one or more times until one or more acceptable teacher-generated responses are produced based on any standard of acceptance. This overall process is characterized as an accuracy-boosting operation insofar as it serves to enhance the accuracy or appropriateness of an original teacher-generated response. As will be described below, the final teacher-generated response serves as a ground-truth response that provides guidance in training the student model 204. But the training system 202 does not inform the student model 204 of how the teacher-generated response was produced by the example-generating system 102. In other words, the accuracy-boosting process performed by the example-generating system 102 is opaque to the training system 202.

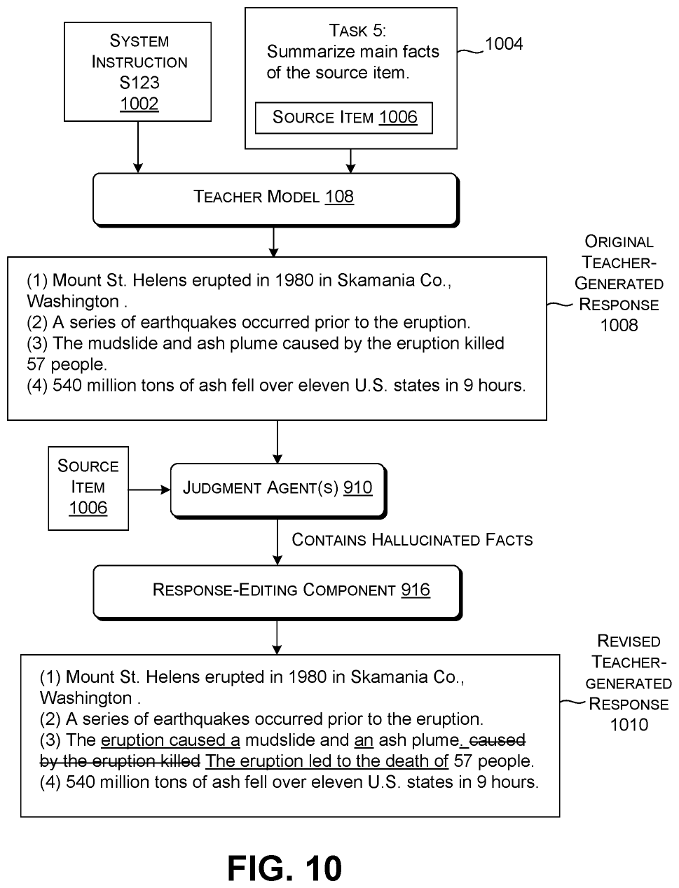

FIG. 10 shows an example of the accuracy-boosting process of FIG. 9. Assume that the teacher model 108 operates on a prompt that includes a system instruction 1002 and a task 1004 that specifies a request to summarize the content of a source item 1006. The teacher model 108 transforms the prompt into a summary, which constitutes an original teacher-generated response 1008. The judgment agent 910 determines whether the original teacher-generated response 1008 includes hallucinations, which are statements that are not supported by the source item 1006. Assume that the judgment agent 910 produces assessment information that indicates that the summary makes a statement about the cause of fatalities that is not fully supported by the original source item 1006. The response-editing component 916 edits the original teacher-generated response 1008 to remove statements that are not supported by the original source item 1006, which yields a revised teacher-generated response 1010.

FIG. 11 shows one implementation of the training system 202 of FIG. 2. The components in FIG. 11 that have the same names and reference numerals as the components in FIG. 2 perform the same functions described above when explaining FIG. 2.

In some implementations, the training system 202 updates the parameters of the student model 204 in a series of iterations, each of which is denoted in FIG. 11 as c. In each iteration, the training system 202 processes a particular batch of that includes B tasks (x_{c1}, x_{c2}, x_{c3}, . . . , x_{cB}), such as 64 tasks. The subscript c, denoting a particular iteration, is henceforth omitted when referring to a task. Assume that the tasks are a series of questions produced by the example-generating system 102 and/or any other system (not shown). For example, one question is the previously generated question: “The explosion of Mt. St. Helens happened during George W. Bush's presidency. True or False?”

In block 1102, the training system 202 initializes c to 1. The training system 202 also initializes the student model 204 at this juncture based on the parameters of an initial model. Assume that the initial model has been produced using supervised fine-tuning to fine-tune a pretrained model.

A policy π_{c} refers to the parameters of the student model 204 in a state associated with a particular iteration c. In a first operation, the student model 204 uses parameters associated with the policy π_{c} to produce a set of K candidate student responses y_{S1}, yₛ₂, . . . , y_{sK} for each task x in the batch. In some implementations, the student model 204 performs this task in an autoregressive manner, e.g., by mapping tokens associated with the questions to the tokens associated with a candidate response, token by token. Additional information regarding the operation of a language model will be set forth below in the description of FIG. 13. In some implementations, a desired ability of the student model 204 to generate different candidate responses for the same prompt x is controlled by choosing a p value and temperature value (e.g., p=0.95 and temperature is 0.7). More specifically, the temperature setting controls the randomness of the responses provided by a language model, and the p value controls the cutoff for token selection in the production of responses.

In a second operation, the judgment agent 206 assigns a reward score to each candidate response yₛ of a task x under consideration of the batch. In some implementations, the judgment agent 206 also assigns a score to the ground-truth response y_{t,gold} for the task. In some implementations, the judgment agent 206 is another language model, such as the teacher model 108 itself.

In some implementations, the training system 202 instructs the teacher model 108 to make a judgment using the particular prompt 1202 shown in FIG. 12. More specifically, this prompt 1202 instructs the teacher model 108 to grade the candidate response with respect to different grading factors, including correctness, relevance to the task, conciseness, etc. The prompt 202 then instructs the teacher model 108 to accumulate the points that a particular candidate response has earned, to arrive at a final reward score r. If there are five candidate responses and one ground-truth response, for instance, the teacher model 108 will produce six reward scores.

Other implementations use other strategies to assess the fitness of a candidate response. For example, another strategy asks the judgment agent 206 to assign a reward score to each candidate student-generated response based on the extent to which it agrees with the ground-truth teacher response. For instance, in some implementations, the judgment agent 206 determines that a match has occurred if the candidate student response exactly matches the ground-truth response, e.g., if the candidate student model specifies option d and the ground-truth response also specifies that the correct response is option d. In other implementations, the judgment agent 206 compares two responses using a vector-based comparison, e.g., by converting the candidate student response into a first distributed vector, converting the ground-truth response into a second distributed vector, determining the distance between the first and second distributed vectors (e.g., using cosine similarity), and comparing the distance to a prescribed threshold value. Still other scoring strategies can be used.

The set-forming component 208 uses application-specific rules to construct subsets (e.g., tuples) on which the parameters of the student model 204 are to be updated. One way to form an illustrative subset (tuple) is described below. As a preliminary operation, in some implementations, the set-forming component 208 ranks the candidate responses for each x from best to worst based on their reward scores. The set-forming component 208 208, and to remove responses having certain defects (such as responses having more than a prescribed number of repeated n-grams). The set-forming component 208 then selects a positive response. In one illustrative rule, the set-forming component 208 only considers an response as an appropriate choice for a positive response (y⁺) if the response has a score above a described threshold value, such as 5 or 6 on a six-point scale (see FIG. 12 for details on this point system). This score will be referred to below as a first score. The set-forming component 208 then selects a negative response for this task only if this response has a score (referred to as a second score) that is lower than the first score (of the positive response) by at least a prescribed number of points (e.g., two points). However, for the case in which a positive response is produced by the student model 204 instead of the teacher model 108, the negative response is deemed acceptable if its score is at least one point lower than the first score of the positive response. The training system 202 improves the quality of its training by accommodating the possibility that the best response may be given by the student model 204, rather than the teacher model 108.

In other implementations, the training system 202 asks the judgment agent 206 to directly compare two or more candidate responses to a question x based on the criteria set forth above, rather than first asking the judgement agent 206 to provide a score for each individual candidate response. That is, the training system 202 can ask the judgment agent 206 to perform a series of pairwise comparisons, or comparisons among three or more candidate responses. In all such implementations, the process of generating training sets (tuples) having a sufficiently large margin between their respective positive and negative responses improves the stability and computational efficiency of the training process.

In some implementations, the set-forming component 208 also draws some subsets from previous iterations (e.g., c−1, c−2, etc.), if there are any such prior iterations, in exponentially decaying amounts (for instance, by drawing at most 30 percent of the subsets from iteration c−1, 15 percent of the subsets from iteration c−2, and so on). This provision helps preserve the preference behavior of the student model 204 from previous iterations so that a newly determined policy does not inadvertently regress to past bad behavior. As an outcome of the above-described processing, the set-forming component 208 stores a preference set D_{c+1} that contains the subsets for use in a subsequent parameter-updating operation. Training is batched in the sense that the training examples are mainly produced from a prescribed batch. Training is “online” because the samples for which training is performed originate, in part, from the policy in its current state at each iteration.

Next, the parameter-updating component 212 updates the parameters of the student model 204 by performing iterative training on the subsets in the preference set D_{c+1}. This operation involves computing an updated policy π_{c+1} for the next iteration c+1. In this computation, the policy πₑ of the current iteration c serves as a reference in the calculations.

In some implementations, the parameter-updating component 212 specifically applies a loss function that is used to find a Nash equilibrium. One such loss function is mathematically expressed as follows:

$${π}_{c + 1} ← {arg max}_{π ∈ \prod } {𝔼}_{( x , {y}_{c}^{+} , {y}_{c}^{-} ) ∼ {D}_{c + 1}} log [ σ ( \tilde{η} log {Y}_{c}^{+} - \tilde{η} log {Y}_{c}^{-} ) ] . \qquad ( 1 )$$

In this Equation, Y_{c}⁺ and Y_{c}⁻ represent:

$${Y}_{c}^{+} = \frac{π ( {y}_{c}^{+} \vert x )}{{π}_{c} ( {y}_{c}^{+} \vert x )} , and {Y}_{c}^{-} = \frac{π ( {y}_{c}^{-} \vert x )}{{π}_{c} ( {y}_{c}^{-} \vert x )} \qquad ( 2 )$$

In these two equations, σ is the sigmoid function, \tilde{η} is a learning rate, [symbol] is the expectation operator, and Π is a policy class. Referring to the denominators of Equation (2), π_{c}(y_{c}⁺|x) is a reference score computed by the student model 204, using the now-fixed parameters of policy πₑ produced in the preceding iteration, for the candidate response y_{c}⁺, given the task x. Similarly, π_{c}(y_{c}⁻|x) is the reference score computed by the student model 204, using the now-fixed parameters of the policy π_{c}, for the candidate response y_{c}⁻, given the task x. Referring to the numerators of Equation (2), π(y_{c}⁺|x) is a score computed by the student model 204, using the parameters being actively updated per Equations (1) and (2), for the candidate response y_{c}⁺, given the task x. Similarly, π(y_{c}⁻|x) is a score computed by the student model 204, using the parameters that are being actively updated, for the candidate response y_{c}⁻, given the task x. The student model 204 computes a score for each candidate response based on the logits associated with the tokens that make up the response, as given by the student model 204.

Overall, Equations (1) and (2) describe how to iteratively finetune the parameters of the student model 204 to promote the preferences set forth in the preference set D_{c+1}. Generally, optimization involves increasing the likelihood that the tasks will result in preferred responses and decreasing the likelihood that the tasks will result in non-preferred responses. Further, when computing π_{c+1}, the version of the student model 204 associated with the policy πₑ for the iteration c serves as reference. Note that even though DPO and like algorithms eliminate the use of a reward function, they implicitly depend on a reward maximization framework. The training system 202 dispenses with reward maximization, and instead performs optimization by finding a Nash equilibrium, given the preferences of the judgement agent 206 (e.g., the teacher model 106).

As indicated in block 1104, when training is complete for the current batch associated with the current iteration, the training system 202 repeats the above-described operation for the next iteration and its associated batch. Alternatively, if the training system 202 determines that training for the last iteration has been completed, the training system 202 uses validation data to evaluate the suitability of the student model 204 at the end of each iteration c. The training system 202 chooses the version of the policy that is assessed as most desirable based on any environment-specific standard of acceptability.

Equations (1) and (2) generally indicate that the parameter-updating component 212 updates the parameters of the student model 204 for a next version of the student model 204 using contrastive loss based, in part, on student-generated responses generated by a current version of the student model 204. This manner of operation can be referred to as self-improving insofar as the student model 204 successively improves its performance for each new version of the student model 204 on the basis of a current version of the student model 204. Further, insofar as the iterative process samples student-generated responses from the most recent version of the student model 204, it may be referred to as “on policy.” Overall, the iterative batched-based technique described above is proven to monotonically improve quality and performance of the student model 204 across iterations.

The above optimization algorithm represents a scalable version of a more general approach to training the student model 204. That more general approach uses a two-step process that involves updating a reward function R_{c}(x,y) for iteration c, per Equation (3) below:

$${R}_{c} ( x , y ) ← {𝔼}_{{y}^{′} ∼ {π}_{c} ( \cdot \vert X )} [ 𝒫 ( y ≻ {y}^{′} \vert x ) ] for all ( x , y ) . \qquad ( 3 )$$

[symbol] (y [symbol] y′|x) refers to a preference function that assigns a preference between two different candidate responses (y and y′), given a task x. In some implementations, the preference function makes a binary choice between two options. In other implementations, the preference function assigns a score to each response within a specified continuous range, e.g., from 0 to 1. More generally, the training system 202 expresses the reward as expected win-rates with regard to the preference function [symbol] .

The second step involves training the policy π_{c+1} based on the reward function R_{C}(x, y):

$${π}_{c + 1} ← {arg max}_{π ∈ \prod } {𝔼}_{( x , {y}_{1} , {y}_{2} ) ∼ {D}_{c}} \{ {G}_{{y}_{1} , {y}_{2}} + {G}_{{y}_{2} , {y}_{1}} \} , where \qquad ( 4 )$$

$${G}_{{y}_{1} , {y}_{2}} = σ ( {R}_{c} ( x , {y}_{1} ) - {R}_{c} ( x , {y}_{2} ) ) log [ σ ( ηlog \frac{π ( {y}_{1} \vert x )}{{π}_{c} ( {y}_{1} \vert x )} - η log \frac{π ( {y}_{2} \vert x )}{{π}_{c} ( {y}_{2} \vert x )} ) ] ,$$

$${G}_{2 , 1} = σ ( {R}_{c} ( x , {y}_{2} ) - {R}_{c} ( x , {y}_{1} ) ) log [ σ ( η log \frac{π ( {y}_{2} \vert x )}{{π}_{c} ( {y}_{2} \vert x )} - η log \frac{π ( {y}_{1} \vert x )}{{π}_{c} ( {y}_{1} \vert x )} ) ] .$$

In this expression, y₁ and Y₂ are two candidate responses sampled by models driven by policies μ_{1,c} and μ_{2,c}, respectively. η is a learning rate, and each quotient in Equation (4) has the same meaning as given above for Equation (3), except now with respect to the candidate responses y₁ and y₂. Optimization performed using Equations (3) and (4) finds the Nash equilibrium for the case of a two-player zero-sum game (as described above). In doing so, the training system 202 optimizes the policy towards the general preferences expressed by [symbol] over plural iterations.

Whereas Equation (4) involves a combination of contrastive updating of parameters and regression, in applying Equations (1) and (2), the training system 202 performs training using only contrastive loss, that is, by eliminating the regression target σ(Rₑ(x,y_{c}⁺−R_{c}(x,y_{c}⁻)) of Equation 4. This is advantageous because a developer typically does not have direct access to the logic that underlies the preferences exhibited by complex systems. It may therefore be difficult to obtain accurate values for this regression computation. The elimination of the regression target also improves the computational efficiency and scalability of the optimization.

In effect, the approach of Equations (1) and (2) can be said to implicitly take account for rewards given by the reward function:

$${R}_{c} ( x , y ) \approx \frac{1}{K} {\sum }_{{y}^{′} ∈ \{ {y}_{s 1} , {y}_{s 2} , … {y}_{s K} , {y}_{t , gold} \} ∖ y} {Sample}_{𝒫} \to [ 0 , 1 ] . \qquad ( 5 )$$

The term Sample [symbol] →[0,1] refers to an operation of sampling from a hypothesized preference function [symbol] and outputting a value of 0 or 1 depending on whether a candidate response y under consideration is better than another candidate response y′∈(yₛ₁, yₛ₂, . . . y_{sK}, y_{t,gold}), given a task x. Equation (5) aggregates the scores over all the candidate responses and divides by the number of candidate responses K.

Note that all implementation of the approach of FIG. 11 perform their optimizations with respect to a single timescale. This factor reduces the complexity of the algorithm (e.g., by reducing the need for complex hyperparameter tuning) and increases its stability.

Overall, the manner in which the training system 202 produces the student model 204 is characterized as direct Nash optimization with general preferences (DNO). That is, the training system 202 performs Nash optimization because it finds a Nash equilibrium given a preference function, which is instantiated as some oracle (e.g., the teacher model 106). The training system 202 is aptly characterized as “direct” by virtue, in part, of its elimination of an explicit reward function in applying Equations (1) and (2), among its other computational efficiencies described above.

The training system 202 of FIG. 11 produces a student model 204 that offers superior performance to other models of the same size (e.g., about 7B parameters) produced by other techniques, and even some models produced by significantly larger models (e.g., in one case, about 70B parameters). For example, the training system 202 increases the performance of the student model 204 over the initial model at the start of training by approximately 26 percent.

FIG. 13 shows the performance of the student model 204 (of size 7B parameters) against various other models. More specifically, FIG. 13 shows the performance of two versions of the DNO (1302, 1304) model produced by the training system 202 of FIG. 11, the version 1302 being trained with more data than the other version 1304. The horizontal axis shows iterations or epochs of training completed. The vertical axis measures the performance of the models against a prescribed bookmark, here the known AlpacaEval benchmark. Additional information regarding this benchmark can be found at Dubois, et al., “AlpacaFarm: A Simulation Framework for Methods that Learn from Human Feedback,” arXiv, arXiv:2305.14387v4 [cs.LG], Jan. 8, 2024, 31 pages.

One competing model is iterative KTO, as described in Ethayarajh, et al., cited above. Another completing model is Offline DPO, as described in Rafilov, et al., cited above. “Offline” means that the algorithm operates during training without sampling from the current policy. Another competing model is supervised fine-tuning (SFT). FIG. 13 also shows the performance of the student model 204 against the initial model, here the Mistral 7B model described in Jiang, et al., “Mistral 7B,” arXiv, arXiv:2310.06825v1 [cs.CL], Oct. 10, 2023, 9 pages. As generally shown in FIG. 13, the DNO models offer superior performance to the other models for all iterations (or epochs) of training.

The quality of responses produced by the DNO model (produced by the training system 202 of FIG. 1) generally improves from iteration to iteration. For example, assume that the question x asks: “When will the earth run out of fresh water?” The initial model, e.g., produced by supervised fine-tuning, may generate an response that is based on the incomplete premise that water will never run out, as it is always being replenished. A second response given by the DNO model may acknowledge that the future availability of fresh water may present a problem in many regions, e.g., by stating, “It is difficult to predict exactly when the Earth will run out of fresh water, as it depends on various factors such as climate change, population growth, water usage, and technological advancements in water management and conservation. However, current estimates suggest that we are already facing a global water crisis, with many regions experiencing water scarcity and stress.” A third response given by the DNO model provides a yet more nuanced and correct response: “It is not accurate to say that the Earth will ‘run out’ of fresh water, but rather that we could potentially deplete or contaminate freshwater resources to a point where they can no longer sustain us. Fresh water is a renewable resource, but its availability depends on various factors such as climate, geography, and human activities. Here are some key points to consider . . . ”

Note that the principles of the training system 202 were set forth above in the context of a teacher-student technique for training a student language model. Other implementations extend the principles to other training environments, such as training in any contextual bandit environment. In a contextual bandit environment, the more general concept of actions replaces the above reference to preferences.

Further note that other implementations vary the algorithms described in Equations (1), (2), and (4) in different ways. For example, another implementation adapts Equations (1), (2), and (4) for the case of regularized (instead of generalized) preferences. This implementation accomplishes this objective by generating student responses for the current iteration c from a smoothed policy π_{c}^{τ}(y|x), which is based on a mix of the current policy π_{c} and a reference policy π_{ref}. In some examples, π_{ref} is the initial model produced by supervised fine-tuning. τ is a coefficient of Kullback-Leibler (KL) divergence.

$${π}_{c}^{τ} ( y \vert x ) := \frac{{{π}_{c} ( y \vert x )}^{1 - τ / η} {{π}_{r e f} ( y \vert x )}^{τ / η}}{{Σ}_{{y}^{′} ∈ 𝒴} ( {{π}_{c} ( y \vert x )}^{1 - τ / η} {{π}_{r e f} ( y \vert x )}^{τ / η} )} . \qquad ( 6 )$$

The numerator of Equation (6) mixes the response from the current policy and the reference policy. η is a learning rate parameter. Overall, the numerator yields a mixed student response \tilde{π}_{c}^{τ}(y|x), and may be viewed as the non-normalized version of π_{cτ given by Equation (}6). The denominator of Equation (6) performs the same computation as the numerator for different candidate responses to the question x, and then sums these results. Dividing the result of the numerator by the sum of the denominator has the effect of providing a normalized and mixed student response. In some implementations, \tilde{π}_{c}^{τ}(y|x) is used for the positive and negative samples in the denominators of Equations (2) and (4).

Another variation uses two or more teacher models to produce the teacher responses, instead of the single teacher model 108 of FIG. 1. More generally, the training system 202 is flexible enough to accommodate the use of responses produced by any type (or types) of ground-truth oracles.

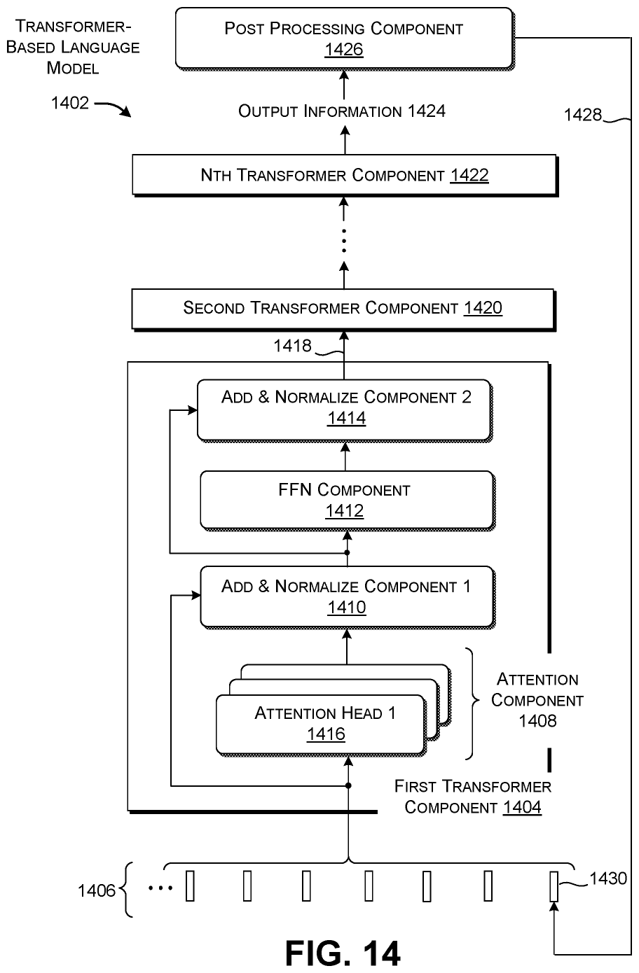

FIG. 14 shows a transformer-based language model 1402, the architecture of which is used to implement the teacher model 108 and the student model 204 according to some implementations. The language model 1402 is composed, in part, of a pipeline of transformer components, including a first transformer component 1404. FIG. 14 provides details regarding one way to implement the first transformer component 1404. Although not specifically illustrated, other transformer components of the language model 1402 have the same architecture and perform the same functions as the first transformer component 1404 (but are governed by separate sets of weights).

The language model 1402 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 1402 operates on any of: audio information, image information, video information, sensor information, and so on, or any combination thereof.

Next, an embedding component (not shown) maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embedding vectors 1406. The position information added to each token embedding describes the embedding vector's position in the sequence of token embeddings.

The first transformer component 1404 operates on the position-supplemented embedding vectors 1406. In some implementations, the first transformer component 1404 includes, in order, an attention component 1408, a first add-and-normalize component 1410, a feed-forward neural network (FFN) component 1412, and a second add-and-normalize component 1414.

The attention component 1408 determines how much emphasis should be placed on parts of input information when interpreting other parts of the input information. Consider, for example, a sentence that reads: “I asked the professor a question, but he could not answer it.” When interpreting the word “it,” the attention component 1408 will determine how much weight or emphasis should be placed on each of the words of the sentence. The attention component 1408 will find that the word “question” is most significant.

The attention component 1408 performs attention analysls using the following equation:

$$Attention ( Q , K , V ) = softmax ( \frac{Q {K}^{T}}{\sqrt{d}} ) V . \qquad ( 7 )$$

The attention component 1408 produces query information Q by multiplying the position-supplemented embedding vectors 1406 by a query weighting matrix W^{Q}. Similarly, the attention component 1408 produces key information K and value information V by multiplying the position-supplemented embedding vectors 1406 by a key weighting matrix W^{K} and a value weighting matrix W^{V}, respectively. To execute Equation (7), the attention component 1408 takes the dot product of Q with the transpose of K, and then divides the dot product by a scaling factor \sqrt{d}, to produce a scaled result. The symbol d represents the dimensionality of Q and K. The attention component 1408 takes the softmax (normalized exponential function) of the scaled result, and then multiplies the result of the softmax operation by V, to produce attention output information. In some cases, the attention component 1408 is said to perform masked attention insofar as the attention component 1408 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 14 shows that the attention component 1408 is composed of plural attention heads, including a representative attention head 1416. Each attention head performs the computations specified by Equation (7), but with respect to a particular representational subspace that is different than the subspaces of the other attention heads. To accomplish this operation, the attention heads perform the computations described above using different respective sets of query, key, and value weight matrices. Although not shown, the attention component 1408 concatenates the output results of the attention component's separate attention heads, and then multiplies the results of this concatenation by another weight matrix W⁰.

The add-and-normalize component 1410 includes a residual connection that combines (e.g., sums) input information fed to the attention component 1408 with the output information generated by the attention component 1408. The add-and-normalize component 1410 then normalizes the output information generated by the residual connection, e.g., by layer-normalizing values in the output information based on the mean and standard deviation of those values, or by performing root-mean-squared normalization. The other add-and-normalize component 1414 performs the same functions as the first-mentioned add-and-normalize component 1410. The FFN component 1412 transforms input information to output information using a feed-forward neural network having any number of layers.

The first transformer component 1404 produces output information 1418. A series of other transformer components (1420, . . . , 1422) perform the same functions as the first transformer component 1404, each operating on output information produced by its immediately preceding transformer component. Each transformer component uses its own level-specific set of machine-trained weights. The final transformer component 1422 in the language model 1402 produces final output information 1424.

In some implementations, a post-processing component 1426 performs post-processing operations on the final output information 1424. For example, the post-processing component 1426 performs a machine-trained linear transformation on the final output information 1424, and processes the results of this transformation using a softmax component (not shown). The language model 1402 uses the output of the post-processing component 1426 to predict the next token in the input sequence of tokens. In some applications, the language model 1402 performs this task using a greedy selection approach (e.g., by selecting the token having the highest probability), or by using the beam search algorithm (e.g., by traversing a tree that expresses a search space of candidate next tokens).

In some implementations, the language model 1402 operates in an auto-regressive manner, as indicated by the loop 1428. To operate in this way, the language model 1402 appends a predicted token to the end of the sequence of input tokens, to provide an updated sequence of tokens. The predicted token leads to the production of a new position-supplemented vector 1430. In a next pass, the language model 1402 processes the updated sequence of position-supplemented vectors to generate a next predicted token. The language model 1402 repeats the above process until it generates a specified stop token.

The above-described implementation of the language model 1402 relies on a decoder-only architecture. Other implementations of the language model 1402 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

Other implementations of the language model 1402 use other kinds of machine-trained models besides, or in addition to, the particular transformer-based architecture shown in FIG. 14. The other machine-trained models include any of convolutional neural networks (CNNs), recurrent neural networks (RNNs), fully-connected feed-forward neural networks (FFNS), stable diffusion models, etc., or any combination thereof.

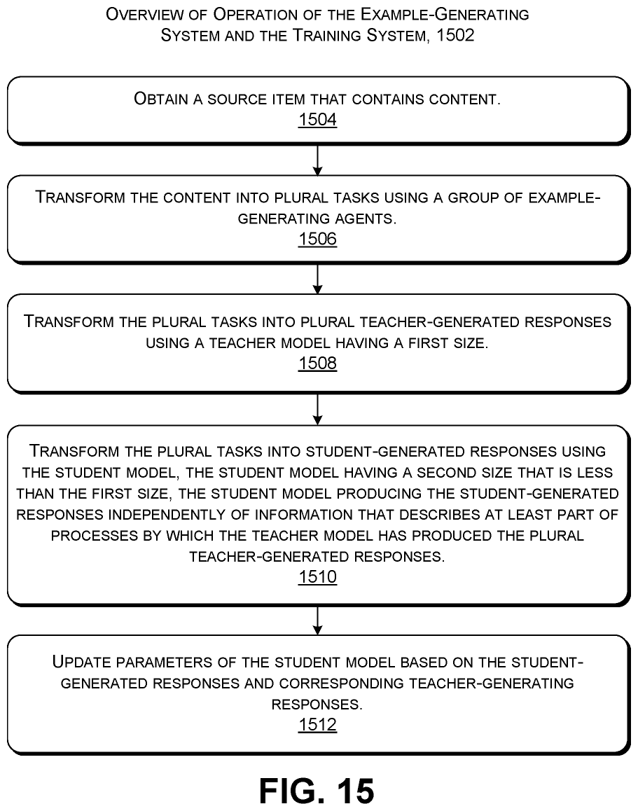

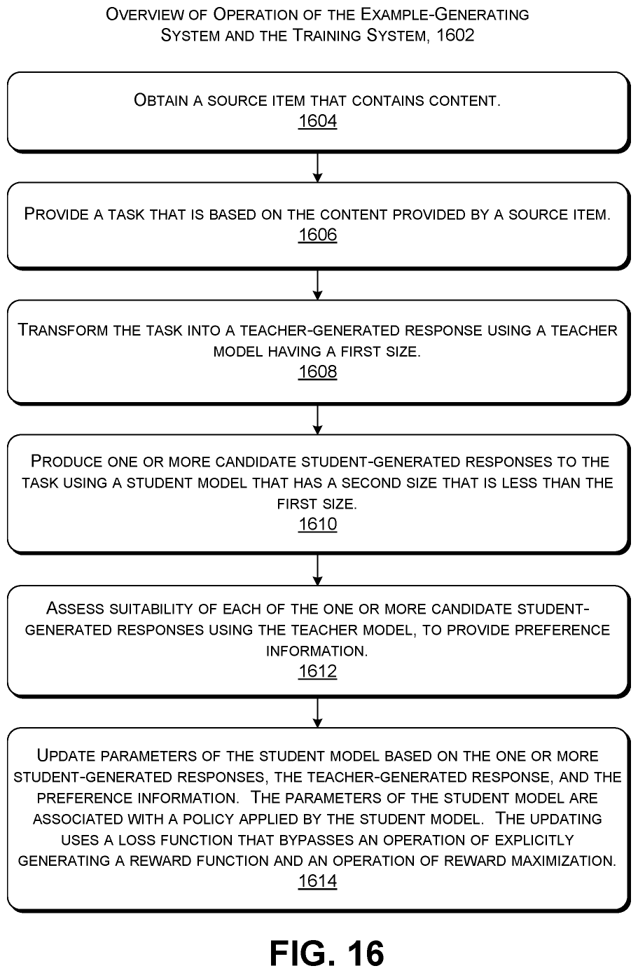

FIGS. 15 and 16 show two processes that represent an overview of the operation of the example-generating system 102 of FIG. 1 and the training system 202 of FIG. 2, respectively. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 3, 4, and 18.

FIG. 15 is a process 1502 that provides an overview of one manner of operation of the example-generating system 102 and the training system 202 of FIGS. 1 and 2, emphasizing the functionality shown in FIG. 1. In block 1504, the example-generating system 102 obtains a source item that contains content. In block 1506, the example-generating system 102 generates plural tasks based on the content using a group of example-generating agents. In block 1508, the example-generating system 102 transforms the plural tasks into plural teacher-generated responses using a teacher model (e.g., the teacher model 108) having a first size. In block 1510, the training system 202 transforms the plural tasks into student-generated responses using a student model (e.g., the student model 204) that has a second size that is less than the first size. More specifically, the student model produces the student-generated responses independently of information that describes at least part of processes by which the teacher model has produced the plural teacher-generated responses. In block 1512, the training system 202 updates parameters of the student model based on the student-generated responses and corresponding teacher-generated responses.

FIG. 16 is a process 1602 that provides another overview of one manner of operation of the example-generating system 102 and the training system 202 of FIGS. 1 and 2, this time emphasizing the functionality shown in FIG. 2. In block 1604, the example-generating system 102 obtains a source item that contains content. In block 1606, the example-generating system 102 provides a task that is based on the content provided by a source item. In block 1608, the example-generating system 102 transforms the task into a teacher-generated response using a teacher model (e.g., the teacher model 108) having a first size. In block 1610, the training system 202 produces one or more candidate student-generated responses to the task using a student model (e.g., the student model 204) that has a second size that is less than the first size. In block 1612, the training system 202 assesses suitability of each of the one or more candidate student-generated responses using the teacher model, to provide preference information, In block 1614, the training system 202 updates parameters of the student model based on the one or more student-generated responses, the teacher-generated response, and the preference information. The parameters of the student model are associated with a policy applied by the student model. Block 1614 uses a loss function that applies contrastive updating of parameters and bypasses an operation of explicitly generating a reward function (and an operation of performing reward maximization). Contrastive updating attends to specified relations among matching and non-matching model responses.

The producing in block 1610, assessing in block 1612, and updating in block 1614 are repeated one or more times to successively improve performance of the student model. In each iteration, the parameters of a next version of the student model are based, in part, on parameters of a current version of the student model, e.g., as reflected in Equation (1) and (2).

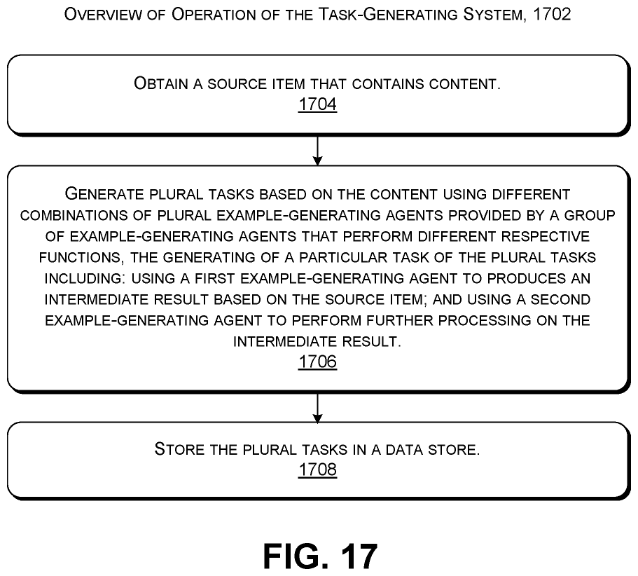

FIG. 17 shows a process 1702 that provides an overview of one manner of operation of the task-generating system 104. In block 1704, the task-generating system 104 obtains a source item that contains content. In block 1706, the task-generating system 104 generates plural tasks based on the content using different combinations of plural example-generating agents provided by a group of example-generating agents that perform different respective functions. In block 1708, the task-generating system 104 stores the plural tasks in a data store. Block 1704 includes: using a first example-generating agent to produces an intermediate result based on the source item; and using a second example-generating agent to perform further processing on the intermediate result.

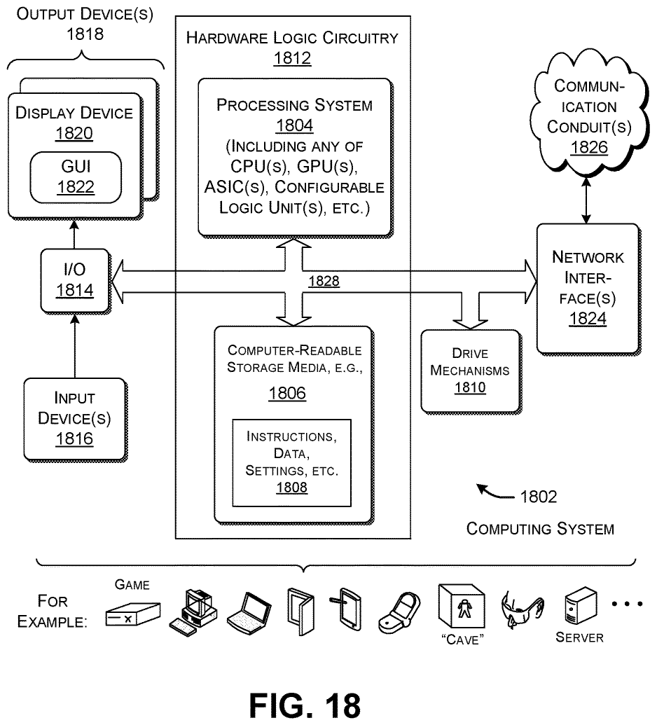

FIG. 18 shows a computing system 1802 that, in some implementations, is used to implement any aspect of the mechanisms set forth in the above-described figures. For instance, in some implementations, the type of computing system 1802 shown in FIG. 18 is used to implement any local computing device or any server shown in FIGS. 3 and 4. In all cases, the computing system 1802 represents a physical and tangible processing mechanism.

The computing system 1802 includes a processing system 1804 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1802 also includes computer-readable storage media 1806, corresponding to one or more computer-readable media hardware units. The computer-readable storage media 1806 retains any kind of information 1808, such as machine-readable instructions, settings, model weights, and/or other data. In some implementations, the computer-readable storage media 1806 includes one or more solid-state devices, one or more hard disks, one or more optical disks, etc. Any instance of the computer-readable storage media 1806 represents a fixed or removable unit of the computing system 1802. Further, any instance of the computer-readable storage media 1806 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1802 utilizes any instance of the computer-readable storage media 1806 in different ways. For example, in some implementations, any instance of the computer-readable storage media 1806 represents a hardware memory unit (such as random access memory (RAM)) for storing information during execution of a program by the computing system 1802, and/or a hardware storage unit (such as a hard disk) for retaining/archiving information on a more permanent basis. In the latter case, the computing system 1802 also includes one or more drive mechanisms 1810 (such as a hard drive mechanism) for storing and retrieving information from an instance of the computer-readable storage media 1806.

In some implementations, the computing system 1802 performs any of the functions described above when the processing system 1804 executes computer-readable instructions stored in any instance of the computer-readable storage media 1806. For instance, in some implementations, the computing system 1802 carries out computer-readable instructions to perform each block of the processes described with reference to FIGS. 15 and 16. FIG. 18 generally indicates that hardware logic circuitry 1812 includes any combination of the processing system 1804 and the computer-readable storage media 1806.

In addition, or alternatively, the processing system 1804 includes one or more other configurable logic units that perform operations using a collection of logic gates, such as field-programmable gate arrays (FPGAs), etc. In these implementations, the processing system 1804 effectively incorporates a storage device that stores computer-readable instructions, insofar as the configurable logic units are configured to execute the instructions and therefore embody or store these instructions.

In some cases (e.g., in the case in which the computing system 1802 represents a user computing device), the computing system 1802 also includes an input/output interface 1814 for receiving various inputs (via input devices 1816), and for providing various outputs (via output devices 1818). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1820 and an associated graphical user interface presentation (GUI) 1822. The display device 1820 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1802 also includes one or more network interfaces 1824 for exchanging data with other devices via one or more communication conduits 1826. One or more communication buses 1828 communicatively couple the above-described units together.

The communication conduit(s) 1826 is implemented in any manner, e.g., by a local area computer network, a wide area computer network (e.g., the Internet), point-to-point connections, or any combination thereof. The communication conduit(s) 1826 include any combination of hardwired links, wireless links, routers, gateway functionality, name servers, etc., governed by any protocol or combination of protocols.

FIG. 18 shows the computing system 1802 as being composed of a discrete collection of separate units. In some cases, the collection of units corresponds to discrete hardware units provided in a computing device chassis having any form factor. FIG. 18 shows illustrative form factors in its bottom portion. In other cases, the computing system 1802 includes a hardware logic unit that integrates the functions of two or more of the units shown in FIG. 18. For instance, in some implementations, the computing system 1802 includes a system on a chip (SoC or SOC), corresponding to an integrated circuit that combines the functions of two or more of the units shown in FIG. 18.

The following summary provides a set of illustrative examples of the technology set forth herein.

(A1) According to one aspect, a method (e.g., the process 1502) is described for training a student model (e.g., the student model 204). The method includes: obtaining (e.g., in block 1504) a source item that contains content; generating (e.g., in block 1506) plural tasks based on the content using a group of example-generating agents; transforming (e.g., in block 1508) the plural tasks into plural teacher-generated responses using a teacher model (e.g., the teacher model 108) having a first size; transforming (e.g., in block 1510) the plural tasks into student-generated responses using the student model, the student model having a second size that is less than the first size. The student model produces the student-generated responses independently of information that describes at least part of processes by which the teacher model has produced the plural teacher-generated responses. The method further includes updating (e.g., in block 1512) parameters of the student model based on the student-generated responses and corresponding teacher-generated responses.

(A2) According to some implementations of the method of A1, at least some of the tasks produced by the group of example-generating agents include questions derived from the content of the source item.

(A3) According to some implementations of the methods of A1 or A2, the group of example-generating agents are organized in a graph, the graph specifying input-output connections among the group of example-generating agents.

(A4) According to some implementations of any of the methods of A1-A3, at least one task is produced using a first example-generating agent that produces an intermediate result, and a second example-generating agent that performs further processing on the intermediate result.

(A5) According to some implementations of any of the methods of A1-A4, the group of example-generating agents performs operations that include one or more of: generating questions based on the source item; and/or rewriting the source item in a specified style; and/or generating code based on the source item; and/or summarizing the source item; and/or specifying an order of statements in the source item; and/or adding detail to the source item.

(A6) According to some implementations of any of the methods of A1-A5, for a particular task, the teacher model produces an original response based on the particular task. The teacher model refines the original response to produce a refined response having enhanced accuracy compared to the original response. The student model produces one or more student responses for the particular task independently of information that describes how the teacher model refined the original response.

(A7) According to some implementations of any of the methods of A1-A6, for a particular task, the teacher model produces an original response based on a first prompt that provides a first instruction. The teacher model produces a refined response based on a second prompt that provides a second instruction that is different than the first instruction. The student model produces one or more student responses for the particular task independently of information that describes at least some aspects of the first instruction and/or the second instruction.

(A8) According to some implementations of the method of A7, the method includes choosing the first instruction based on an assessment of a class associated with the particular task.

(A9) According to some implementations of any of the methods of A1-A8, the transforming of the tasks by the student model includes, for a particular task: producing one or more candidate student-generated responses to the particular task; and assessing suitability of each of the one or more candidate student-generated responses using the teacher model, to provide preference information. The updating of the parameters of the student model is based on the one or more student-generated responses, a teacher-generated response to the particular task, and the preference information. The parameters of the student model are associated with a policy applied by the student model. The method further includes repeating the producing, assessing, and updating one or more times to successively improve performance of the student model. In each repetition of the updating, the parameters of a next version of the student model are based, in part, on parameters of a current version of the student model.

(A10) According to some implementations of the method of A9, the method performs optimization based on the preference information to find a stable policy for application by the student model, among competing policies, that satisfies a Nash equilibrium, the Nash equilibrium being a state in which there is no incentive to move from the stable policy to a competing policy.

(A11) According to some implementations of the methods of A9 and A10, the updating uses a loss function that bypasses an operation of explicitly generating a reward function and an operation of performing reward maximization.

(A12) According to some implementations of any of the methods of A9-A11, the method further includes generating a subset for the particular task that includes a first candidate student-generated response that is determined to be a suitable response to the particular task and a second candidate student-generated response that is determined be a less suitable response to the task compared to the first candidate student-generated response. The updating attends to relations among the particular task, the first candidate student-generated task, and the second candidate-generated task as specified in the subset.

(A13) A machine-trained model having parameters produced by any of the methods of A1-A12.

(B1) According to another aspect, a method (e.g., the process 1602) is described for training a student model (e.g., the student model 204). The method includes: obtaining (e.g., in block 1604) a source item that contains content; providing (e.g., in block 1606) a task that is based on the content provided by a source item; transforming (e.g., in block 1608) the task into a teacher-generated response using a teacher model (e.g., the teacher model 108) having a first size; producing (e.g., in block 1610) one or more candidate student-generated responses to the task using a student model that has a second size that is less than the first size; assessing (e.g., in block 1612) suitability of each of the one or more candidate student-generated responses using the teacher model, to provide preference information; and updating (e.g., in block 1614) parameters of the student model based on the one or more student-generated responses, the teacher-generated response, and the preference information. The parameters of the student model are associated with a policy applied by the student model. The updating uses a loss function that bypasses an operation of explicitly generating a reward function and an operation of reward maximation. The method repeats the producing, assessing, and updating one or more times to successively improve performance of the student model. In each repetition of the updating, the parameters of a next version of the student model are based, in part, on parameters of a current version of the student model.

(B2) According to some implementations of the method of B1, the method performs optimization based on the preference information to find a stable policy for application by the student model, among competing policies, that satisfies a Nash equilibrium, the Nash equilibrium being a state that minimizes worst-case assessments of loss.

(B3) According to some implementations of the methods of B1, the method performs optimization based on the preference information to find a stable policy for application by the student model, among competing policies, that satisfies a Nash equilibrium. The Nash equilibrium is a state in which each entity in a non-cooperative environment makes a decision that the entity considers optimal for the entity, given knowledge of decisions made by other entities with which the entity interacts.

(B4) According to some implementations of any of the methods of B1-B3, the assessing suitability is performed by prompting the teacher model to assign one or more points to a particular candidate student-generated response based on an extent to which the particular candidate student-generated response has one or more specified characteristics.

(B5) According to some implementations of any of the methods of B1-B4, the operations further include generating a subset for the task that includes a first candidate student-generated response that is determined to be a suitable response to the task and a second candidate student-generated response that is determined be a less suitable response to the task compared to the first candidate-student-generated response. The updating attends to relations among the task, the first candidate student-generated task, and the second candidate-generated task as specified in the subset.

(B6) According to some implementations of any of the method of B5, the operations further include choosing the first candidate student-generated response in response to determining that the first candidate student-generated response has a first score that satisfies a prescribed test of suitability, and choosing the second candidate student-generated response upon determining that the second student-generated response has a second score that is worse than the first score by at least a prescribed amount.

(B7) According to some implementations of any of the methods of B1-B5, the providing the task includes using one or more example-generating agents of a group of example-generating responses to produce the task based on the source item.

(C1) According to another aspect, a method (e.g., the process 1702) is described for generating plural tasks using the task-generating system 104. The method includes: obtaining (e.g., in block 1704) a source item that contains content; generating (e.g., in block 1706) plural tasks based on the content using different combinations of plural example-generating agents provided by a group of example-generating agents that perform different respective functions; and storing (e.g., in block 1708) the plural tasks in a data store (e.g., the data store 106). The generating of a particular task of the plural tasks includes: using a first example-generating agent to produces an intermediate result based on the source item; and using a second example-generating agent to perform further processing on the intermediate result.

In yet another aspect, some implementations of the technology described herein include a computing system (e.g., the computing system 1802) that includes a processing system (e.g., the processing system 1804) having a processor. The computing system also includes a storage device (e.g., the computer-readable storage media 1806) for storing computer-readable instructions (e.g., the information 1808). The processing system executes the computer-readable instructions to perform any of the methods described herein (e.g., any individual method of the methods of A1-A13, B1-B7, or C1).

In yet another aspect, some implementations of the technology described herein include a computer-readable storage medium (e.g., the computer-readable storage media 1806) for storing computer-readable instructions (e.g., the information 1808). A processing system (e.g., the processing system 1804) executes the computer-readable instructions to perform any of the operations described herein (e.g., the operations in any individual method of the methods of A13, B1-B7, or C1.

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1812 of FIG. 18. The term “logic” likewise encompasses various physical and tangible mechanisms for performing a task. For instance, each processing-related operation illustrated in the flowcharts of FIGS. 15 and 16 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training a student model, comprising:
obtaining a source item that contains content;
generating plural tasks based on the content using a group of example-generating agents;
transforming the plural tasks into plural teacher-generated responses using a teacher model having a first size;
transforming the plural tasks into student-generated responses using the student model, the student model having a second size that is less than the first size,
the student model producing the student-generated responses independently of information that describes at least part of processes by which the teacher model has produced the plural teacher-generated responses; and
updating parameters of the student model based on the student-generated responses and corresponding teacher-generated responses.

2. The method of claim 1, wherein at least some of the tasks produced by the group of example-generating agents include questions derived from the content of the source item.

3. The method of claim 1, wherein the group of example-generating agents are organized in a graph, the graph specifying input-output connections among the group of example-generating agents.

4. The method of claim 1, wherein at least one task is produced using a first example-generating agent that produces an intermediate result, and a second example-generating agent that performs further processing on the intermediate result.

5. The method of claim 1, wherein the group of example-generating agents performs operations that include one or more of:
generating questions based on the source item; and/or
rewriting the source item in a specified style; and/or
generating code based on the source item; and/or
summarizing the source item; and/or
specifying an order of statements in the source item; and/or
adding detail to the source item.

6. The method of claim 1, wherein, for a particular task, the teacher model produces an original response based on the particular task, and wherein the teacher model refines the original response to produce a refined response having enhanced accuracy compared to the original response, and wherein the student model produces one or more student responses for the particular task independently of information that describes how the teacher model refined the original response.

7. The method of claim 1, wherein, for a particular task, the teacher model produces an original response based on a first prompt that provides a first instruction, and wherein the teacher model produces a refined response based on a second prompt that provides a second instruction that is different than the first instruction, and wherein the student model produces one or more student responses for the particular task independently of information that describes at least some aspects of the first instruction and/or the second instruction.

8. The method of claim 7, further comprising choosing the first instruction based on an assessment of a class associated with the particular task.

9. The method of claim 1, wherein the transforming of the tasks by the student model includes, for a particular task:
producing one or more candidate student-generated responses to the particular task; and
assessing suitability of each of the one or more candidate student-generated responses using the teacher model, to provide preference information,
the updating of the parameters of the student model being based on the one or more student-generated responses, a teacher-generated response to the particular task, and the preference information, the parameters of the student model being associated with a policy applied by the student model,
the producing, assessing, and updating being repeated one or more times to successively improve performance of the student model,
in each repetition of the updating, the parameters of a next version of the student model being based, in part, on parameters of a current version of the student model.

10. The method of claim 9, wherein the method performs optimization based on the preference information to find a stable policy for application by the student model, among competing policies, that satisfies a Nash equilibrium, the Nash equilibrium being a state in which there is no incentive to move from the stable policy to a competing policy.

11. The method of claim 9, wherein the updating uses a loss function that bypasses an operation of explicitly generating a reward function and an operation of performing reward maximization.

12. The method of claim 9, further comprising:
generating a subset for the particular task that includes a first candidate student-generated response that is determined to be a suitable response to the particular task and a second candidate student-generated response that is determined be a less suitable response to the task compared to the first candidate student-generated response,
the updating attending to relations among the particular task, the first candidate student-generated task, and the second candidate-generated task as specified in the subset.

13. A machine-trained model having parameters produced by the method of claim 1.

14. A computing system for training a student model, comprising:
an instruction data store for storing computer-readable instructions; and
a processing system for executing the computer-readable instructions in the data store, to perform operations including:
obtaining a source item that contains content;
providing a task that is based on the content provided by a source item;
transforming the task into a teacher-generated response using a teacher model having a first size;
producing one or more candidate student-generated responses to the task using a student model that has a second size that is less than the first size;
assessing suitability of each of the one or more candidate student-generated responses using the teacher model, to provide preference information; and
updating parameters of the student model based on the one or more student-generated responses, the teacher-generated response, and the preference information, the parameters of the student model being associated with a policy applied by the student model,
the updating using a loss function that bypasses an operation of explicitly generating a reward function and an operation of reward maximation,
the producing, assessing, and updating being repeated one or more times to successively improve performance of the student model,
in each repetition of the updating, the parameters of a next version of the student model being based, in part, on parameters of a current version of the student model.

15. The computing system of claim 14, wherein the method performs optimization based on the preference information to find a stable policy for application by the student model, among competing policies, that satisfies a Nash equilibrium, the Nash equilibrium being a state that minimizes worst-case assessments of loss.

16. The computing system of claim 14, wherein the assessing suitability is performed by prompting the teacher model to assign one or more points to a particular candidate student-generated response based on an extent to which the particular candidate student-generated response has one or more specified characteristics.

17. The computing system of claim 14, wherein the operations further comprise:
generating a subset for the task that includes a first candidate student-generated response that is determined to be a suitable response to the task and a second candidate student-generated response that is determined be a less suitable response to the task compared to the first candidate-student-generated response,
the updating attending to relations among the task, the first candidate student-generated task, and the second candidate-generated task as specified in the subset.

18. The computing system of claim 17, wherein the operations further comprise choosing the first candidate student-generated response in response to determining that the first candidate student-generated response has a first score that satisfies a prescribed test of suitability, and choosing the second candidate student-generated response upon determining that the second student-generated response has a second score that is worse than the first score by at least a prescribed amount.

19. The computing system of claim 14, wherein the providing the task includes using one or more example-generating agents of a group of example-generating responses to produce the task based on the source item.

20. A computer-readable storage medium for storing computer-readable instructions, a processing system executing the computer-readable instructions to perform operations comprising:
obtaining a source item that contains content;
generating plural tasks based on the content using different combinations of plural example-generating agents provided by a group of example-generating agents that perform different respective functions; and
storing the plural tasks in a data store,
the generating of a particular task of the plural tasks including:
using a first example-generating agent to produces an intermediate result based on the source item; and
using a second example-generating agent to perform further processing on the intermediate result.
